(19) United States
(12) Patent Application Publication
(10) Pub. No.: US 2021/0024053 A1
(43) Pub. Date: Jan. 28, 2021

(54) DRIVE APPARATUS OF HYBRID VEHICLE

(71) Applicant: Honda Motor Co., Ltd., Tokyo (JP)

(72) Inventor: Takahiro Kasahara, Wako-shi, Saitama (JP)

(21) Appl. No.: 16/965,932

(22) PCT Filed: Jan. 21, 2019
(86) PCT No.: PCT/JP2019/001588

§ 371 Date: Jul. 29, 2020

(30) Foreign Application Priority Data
Feb. 13, 2018 (JP) 2018-022701

(51) Int. Cl. B60W 20/20; F16H 3/72; B60K 6/387; B60W 10/06; B60W 10/08; B60K 6/445; B60K 6/442; B60W 20/30; B60W 20/40; B60K 6/365; B60K 6/547

(52) U.S. Cl. CPC B60W 20/20; F16H 3/72; B60K 6/387; B60W 10/06; B60W 10/08; B60K 6/445; B60K 2006/381; B60W 20/30; B60W 20/40; B60K 6/365; B60K 6/547; B60Y 2200/92; B60K 6/442

(57) ABSTRACT

A drive apparatus of a hybrid vehicle includes an internal combustion engine, a first planetary gear mechanism, a first motor-generator, a second planetary gear mechanism, a path forming part forming a power transmission path so as to transmit power output from a sun gear of the second planetary gear mechanism to a wheel axle, a second motor-generator connected to the power transmission path transmitting power to the wheel axle through the power transmission path, a one-way clutch interposed between the sun gear and the second motor-generator, a brake mechanism braking or non-braking the ring gear of the second planetary gear mechanism, a clutch mechanism integrally joining the sun gear and the ring gear of the second planetary gear mechanism or separate from each other, and an electronic control unit controlling the brake mechanism and the clutch mechanism.

### TECHNICAL FIELD

This invention relates to a drive apparatus of a hybrid vehicle.

### BACKGROUND ART

Conventionally, there is a known apparatus of this type that includes an engine and electric motor as a power source for driving a vehicle, a power splitting planetary gear mechanism able to split power generated by the engine between output side and electric motor side, and a speed ratio changing planetary gear mechanism able to transmit power generated by the engine to the output side through two path (for example, see Patent Literature 1). In the apparatus described in Patent Literature 1, engaging operations of one brake device and two crutch devices are controlled, and therefore, drive mode can be switched to one of three drive modes including EV mode, series mode and HV mode, and further speed ratio is changed to low speed range or high speed range in the HV mode.

### CITATION LIST

### Patent Literature

Patent Literature 1: Japanese Examined Patent Publication No. 5391959

### DISCLOSURE OF INVENTION

### Problems to be Solved by the Invention

However, since apparatus described in Patent Literature 1 implements speed ratio changing in HV mode by controlling engaging operation of one brake device and two clutch devices, there has been the problem of complicated configuration and it is difficult to enhance the response of speed ratio changing.

### Means for Solving Problem

An aspect of the present invention is a drive apparatus of a hybrid vehicle including: an internal combustion engine; a first planetary gear mechanism to which a power generated by the internal combustion engine is input; a first motor-generator connected to the first planetary gear mechanism; a second planetary gear mechanism including a sun gear, a carrier and a ring gear so that a power output from the first planetary gear mechanism is input to the second planetary gear mechanism through the carrier; a path forming part configured to form a power transmission path so as to transmit a power output from the sun gear of the second planetary gear mechanism to a wheel axle; a second motor-generator connected to the power transmission path to transmit a power to the wheel axle through the power transmission path; a one-way clutch interposed between the sun gear of the second planetary gear mechanism and an output shaft of the second motor-generator in the power transmission path to allow a relative rotation of the output shaft with respect to the sun gear in one direction and prohibit the relative rotation of the output shaft in an opposite direction; a brake mechanism configured to brake or non-brake the ring gear of the second planetary gear mechanism by engaging or disengaging; a clutch mechanism configured to integrally join the sun gear and the ring gear of the second planetary gear mechanism or separate from each other by engaging or disengaging; and an electronic control unit configured to control the brake mechanism and the clutch mechanism.

### Effect of the Invention

According to the present invention, it is possible to easily enhance the response of speed ratio changing by using a brake mechanism and a clutch mechanism with a simple configuration.

### BRIEF DESCRIPTION OF THE DRAWINGS

FIG. 1 is a skeleton diagram showing schematically a configuration overview of a drive apparatus of a hybrid vehicle according to an embodiment of the invention;

FIG. 2 is a diagram showing an interconnection of main components of the drive apparatus of the hybrid vehicle according to the embodiment of the invention;

FIG. 3 is a diagram an example of drive modes implemented by the drive apparatus of the hybrid vehicle according to the embodiment of the invention;

FIG. 4 is a skeleton diagram showing a flow of torque transmission in EV mode in the drive apparatus of FIG. 1;

FIG. 5 is a skeleton diagram showing a flow of torque transmission in W motor mode in the drive apparatus of FIG. 1;

FIG. 6 is a skeleton diagram showing a flow of torque transmission in series mode in the drive apparatus of FIG. 1;

FIG. 7 is a skeleton diagram showing a flow of torque transmission in HV low mode in the drive apparatus of FIG. 1;

FIG. 8 is a skeleton diagram showing a flow of torque transmission in HV high mode in the drive apparatus of FIG. 1;

FIG. 9 is a diagram showing characteristic curves of driving force and power corresponding to vehicle speed in HV low mode and HV high mode;

FIG. 10A is an alignment chart showing an example of operation in EV mode;

FIG. 10B is an alignment chart showing an example of operation in W motor mode;

FIG. 10C is an alignment chart showing an example of operation when starting an engine from EV mode;

FIG. 10D is an alignment chart showing an example of operation in HV high mode;

FIG. 10E is an alignment chart showing an example of operation in HV low mode;

FIG. 11 is a block diagram showing an example of modification of control apparatus included in the drive apparatus of FIG. 1;

FIG. 12 is a skeleton diagram showing a modification of FIG. 1; and

FIG. 13 is a skeleton diagram showing another modification of FIG. 1.

### DESCRIPTION OF EMBODIMENT

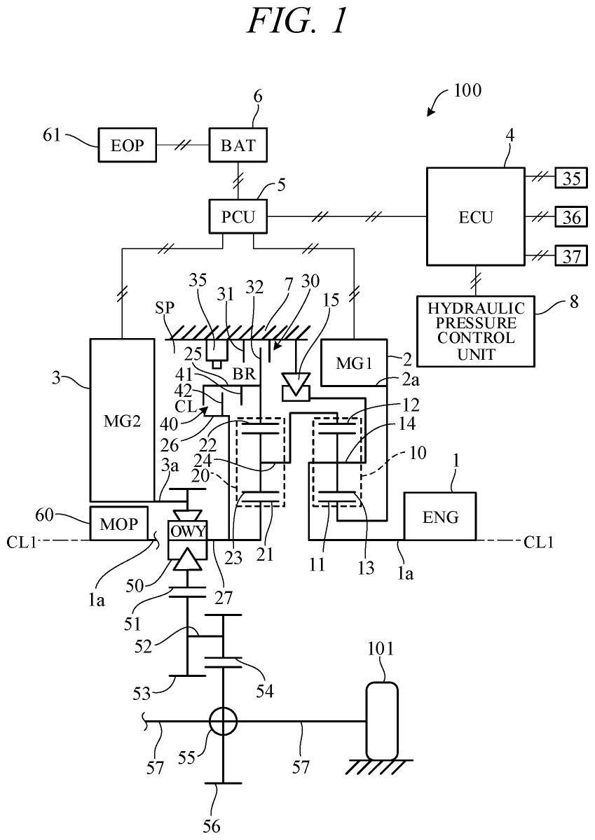

Hereinafter, an embodiment of the present invention is explained with reference to FIGS. 1 to 13. A drive apparatus according to an embodiment of the present invention is applied to a hybrid vehicle including an engine and a motor-generator as a drive power source. FIG. 1 is a skeleton diagram showing schematically a configuration overview of a drive apparatus 100 according to the present embodiment.

As shown in FIG. 1, the drive apparatus 100 includes an engine (ENG) 1, first and second motor-generators (MG1 and MG2) 2 and 3, a first planetary gear mechanism 10 for dividing motive power, and a second planetary gear mechanism 20 for changing speed ratio. The drive apparatus 100 is mounted at front of a vehicle, and motive power of the drive apparatus 100 is transmitted to front wheels 101. The vehicle is thus structured as a front-wheel-drive (i.e., FF layout) vehicle.

The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. Throttle valve opening and quantity of fuel injected from the injector (injection time and injection time period), controlled by a controller (ECU) 4. An output shaft 1a of the engine 1 extends centered on axis CL1.

The first and second motor-generators 2 and 3 each has a substantially cylindrical rotor centered on axis CL1 and a substantially cylindrical stator installed around the rotor and can function as a motor and as a generator. Namely, the rotors of the first and second motor-generators 2 and 3 are driven by electric power supplied from a battery 6 through a power control unit (PCU) 5 to coils of the stators. In such case, the first and second motor-generators 2 and 3 function as motors.

On the other hand, when rotating shafts 2a and 3a of rotors of the first and second motor-generators 2 and 3 are driven by external forces, the first and second motor-generators 2 and 3 generate electric power that is applied through the power control unit 5 to charge the battery 6. In such case, the first and second motor-generators 2 and 3 function as generators. During normal vehicle traveling, such as during cruising or acceleration, for example, the first motor-generator 2 functions chiefly as a generator and the second motor-generator 3 functions chiefly as a motor.

An outer diameter of the first motor-generator 2 and an outer diameter of the second motor-generator 3 are almost equal to each other. On the other hand, an inner diameter of the first motor-generator 2 (rotor) is greater than an inner diameter of the second motor-generator 3 (rotor). The first motor-generator 2 and the second motor-generator 3 are coaxially installed at spaced locations. Therefore, the drive apparatus 100 can be downsized as a whole, compared to one in which a pair of motor-generators are not coaxially installed.

The first motor-generator 2 and second motor-generator 3 are, for example, housed in a common case 7, and a space SP between them is enclosed by the case 7. Optionally, the first motor-generator 2 and second motor-generator 3 can be housed in separate cases.

The first planetary gear mechanism 10 and second planetary gear mechanism 20 are installed in the space SP between the first motor-generator 2 and second motor-generator 3. Specifically, the first planetary gear mechanism 10 is situated on the side of the first motor-generator 2 and the second planetary gear mechanism 20 on the side of the second motor-generator 3. In particular, the first planetary gear mechanism 10 is installed in radial inner side of the first motor-generator 2. Therefore, the drive apparatus 100 can be configured compact in axial direction.

The first planetary gear mechanism 10 includes a first sun gear 11 and a first ring gear 12 installed around the first sun gear 11, both of which rotate around axis CL1, multiple circumferentially spaced first pinions (planetary gears) 13 installed between the first sun gear 11 and first ring gear 12 to mesh with these gears 11 and 12, and a first carrier 14 that supports the first pinions 13 to be individually rotatable around their own axes and collectively revolvable around axis CL1.

Similarly to the first planetary gear mechanism 10, the second planetary gear mechanism 20 includes a second sun gear 21 and a second ring gear 22 installed around the second sun gear 21, both of which rotate around axis CL1, multiple circumferentially spaced second pinions (planetary gears) 23 installed between the second sun gear 21 and second ring gear 22 to mesh with these gears 21 and 22, and a second carrier 24 that supports the second pinions 23 to be individually rotatable around their own axes and collectively revolvable around axis CL1.

The output shaft 1a of the engine 1 is connected to the first carrier 14, and power of the engine 1 is input to the first planetary gear mechanism 10 through the first carrier 14. On the other hand, when the engine 1 is started, power from the first motor-generator 2 is input to the engine 1 through the first planetary gear mechanism 10. The first carrier 14 is connected to a one-way clutch 15 provided on an inner peripheral surface of a surrounding wall of the case 7. The one-way clutch 15 allows forward rotation of the first carrier 14, i.e., rotation in same direction as that of the engine 1, and prohibits reverse rotation. Provision of the one-way clutch 15 prevents the engine 1 from being reversely rotated by reverse torque acting through the first carrier 14.

The first sun gear 11 is connected to the rotating shaft 2a of the rotor of the first motor-generator 2, and the first sun gear 11 and first motor-generator 2 (rotor) rotate integrally. The first ring gear 12 is connected to the second carrier 24, and the first ring gear 12 and second carrier 24 rotate integrally. Owing to this configuration, the first planetary gear mechanism 10 can output power received from the first carrier 14 through the first sun gear 11 to the first motor-generator 2 and output power through the first ring gear 12 to the second carrier 24 on an axle 57 side. In other words, it can dividedly output power from the engine 1 to the first motor-generator 2 and the second planetary gear mechanism 20.

An axis CL1-centered substantially cylindrical outer drum 25 is provided radially outside the second ring gear 22. The second ring gear 22 is connected to and rotates integrally with the outer drum 25. A brake mechanism 30 is provided radially outward of the outer drum 25. The brake mechanism 30 is, for example, structured as a multi-plate wet brake including multiple radially extending plates (friction members) 31 arranged in axial direction and multiple radially extending disks (friction members) 32 arranged in axial direction (multiple illustration is omitted in the drawing). The plates 31 and disks 32 are alternately arranged in axial direction. The multiple plates 31 are circumferentially non-rotatably and axially movably engaged at their radial outer ends with the inner peripheral surface of the surrounding wall of the case 7. The multiple disks 32 are engaged at their radial inner ends with the outer peripheral surface of the outer drum 25 to be circumferentially non-rotatably and axially movably relative to the outer drum 25.

The brake mechanism 30 includes a spring (not shown) for applying biasing force acting to separate the plates 31 and disks 32 and thus release the disks 32 from the plates 31, and a piston (not shown) for applying pushing force acting against the biasing force of the spring to engage the plates 31 and disks 32. The piston is driven by hydraulic pressure supplied through a hydraulic pressure control unit 8. In a state with no hydraulic pressure acting on the piston, the plates 31 and disks 32 separate, thereby disengaging (turning OFF) the brake mechanism 30 and allowing rotation of the second ring gear 22. On the other hand, when hydraulic pressure acts on the piston, the plates 31 and disks 32 engage, thereby operating (turning ON) the brake mechanism 30. In this state, rotation of the second ring gear 22 is prevented.

An axis CL1-centered substantially cylindrical inner drum 26 is provided radially inward of and facing the outer drum 25. The second sun gear 21 is connected to an output shaft 27 of a second planetary gear mechanism 20 that extends along axis CL1 and is connected to the inner drum 26, whereby the second sun gear 21, output shaft 27 and inner drum 26 rotate integrally. A clutch mechanism 40 is provided between the outer drum 25 and the inner drum 26.

The clutch mechanism 40 is, for example, structured as a multi-plate wet clutch including multiple radially extending plates (friction members) 41 arranged in axial direction and multiple radially extending disks (friction members) 42 arranged in axial direction (multiple illustration is omitted in the drawing). The plates 41 and disks 42 are alternately arranged in axial direction. The multiple plates 41 are engaged at their radial outer ends with the inner peripheral surface of the outer drum 25 to be circumferentially non-rotatable and axially movable relative to the outer drum 25. The multiple disks 42 are engaged at their radial inner ends with outer peripheral surface of the inner drum 26 to be circumferentially non-rotatable and axially movable relative to the inner drum 26.

The clutch mechanism 40 includes a spring (not shown) for applying biasing force acting to separate the plates 41 and disks 42 and thus release the disks 42 from the plates 41, and a piston (not shown) for applying pushing force acting against the biasing force of the spring to engage the plates 41 and disks 42. The piston is driven by hydraulic pressure supplied through the hydraulic pressure control unit 8.

In a state with no hydraulic pressure acting on the piston, the plates 41 and disks 42 separate, thereby disengaging (turning OFF) the clutch mechanism 40 and allowing relative rotation of the second sun gear 21 with respect to the second ring gear 22. When rotation of the second ring gear 22 is prevented by the brake mechanism 30 being ON at this time, rotation of the output shaft 27 with respect to the second carrier 24 is accelerated. This state corresponds to speed ratio stage being shifted to high.

On the other hand, when hydraulic pressure acts on the piston, the plates 41 and disks 42 engage, thereby operating (turning ON) the clutch mechanism 40 and integrally joining the second sun gear 21 and second ring gear 22. When rotation of the second ring gear 22 is allowed by the brake mechanism 30 being OFF at this time, the output shaft 27 becomes integral with the second carrier 24 and rotates at the same speed as the second carrier 24. This state corresponds to speed ratio stage being shifted to low.

In the present embodiment, elements of the second planetary gear mechanism 20 are respectively configured so that the rate (α2/α1) of speed ratio α2 when speed ratio stage being shifted to low relative to speed ratio al when speed ratio stage being shifted to high, i.e., step ratio, becomes a relatively large value (for example, 1.8 or more). Therefore, traveling in range from low-speed and high-torque to high-speed and low-torque can be easily carried out and high travel performance can be achieved.

The brake mechanism 30 and the clutch mechanism 40 are structured as multi-plate wet brake and multi-plate wet clutch, and cooling oil is supplied to these mechanisms. In this connection, heating value of friction elements (clutch mechanical 40) for implementing low speed range is generally smaller than heating value of friction elements (brake mechanism 30) for implementing high speed range. In the present embodiment, when the clutch mechanism 40 is turned ON, the disk 42 of the inner drum 26 connected to the second sun gear 21 is engaged with the plate 41 of the outer drum 25 connected to the second ring gear 22. Therefore, the clutch mechanism 40 is configured to be smaller transmission torque capacity than input torque through the second carrier 24. As a result, it is possible to decrease the number of friction plates and to downsize the clutch mechanism 40.

Further, since the brake mechanism 30 is provided on the inner peripheral surface of the surrounding wall of the case 7, it is possible to form an oil passage for supplying cooking oil to the brake mechanism 30 by passing through the case 7. Therefore, an amount of cooling oil supplied to the brake mechanism 30 from the rotating shaft (output shaft 27) side is reduced, and it is not necessary to supply high pressure oil such as brake fluid to the brake mechanism 30 from the rotating shaft side. Accordingly, it is possible to supply cooling oil and high pressure oil (brake fluid) to the brake mechanism 30 with a simple configuration and improve hydraulic response.

The output shaft 27 is connected through a one-way clutch 50 to an output gear 51 centered on axis CL1. The one-way clutch 50 allows forward rotation of the output gear 51 with respect to the output shaft 27, i.e., relative rotation corresponding to vehicle forward direction, and prohibits rotation corresponding to vehicle reverse direction. In other words, when rotational speed of the output shaft 27 corresponding to vehicle forward direction is faster than rotational speed of the output gear 51, the one-way clutch 50 locks, whereby the output shaft 27 and output gear 51 rotate integrally. On the other hand, when rotational speed of the output gear 51 corresponding to vehicle forward direction is faster than rotational speed of the output shaft 27, the one-way clutch 50 disengages, whereby the output gear 51 freely rotates with respect to the output shaft 27 without torque pulled back.

A rotating shaft 3a of the rotor of the second motor-generator 3 is connected to the output gear 51, so that the output gear 51 and the second motor-generator 3 (rotating shaft 3a) rotate integrally. Since the one-way clutch 50 is interposed between the output shaft 27 and the rotating shaft 3a, forward relative rotation of the rotating shaft 3a with respect to the output shaft 27 is allowed. In other words, when rotational speed of the second motor-generator 3 is faster than rotational speed of the output shaft 27, the second motor-generator 3 efficiently rotates without torque of the output shaft 27 (second planetary gear mechanism 20) pulled back. The one-way clutch 50 is installed radially inward of the rotating shaft 3a. Since axial length of the drive apparatus 100 can therefore be minimized, a smaller drive apparatus 100 can be realized.

An oil pump (MOP) 60 is installed radially inward of the rotor of the second motor-generator 3. The oil pump 60 is connected to the output shaft 1a of the engine 1 and driven by the engine 1. Due to such an arrangement of the oil pump 60, the drive apparatus 100 is downsized as a whole. Oil supply necessary when the engine 1 is stopped is covered by driving an electric pump (EOP) 61 with power from the battery 6.

A large-diameter gear 53 rotatable around a counter shaft 52 lying parallel to axis CL1 meshes with the output gear 51, and torque is transmitted to the counter shaft 52 through the large-diameter gear 53. Torque transmitted to the counter shaft 52 is transmitted through a small-diameter gear 54 to a ring gear 56 of a differential unit 55 and further transmitted through the differential unit 55 to the left and right axles (drive shaft) 57. Since this drives the front wheels 101, the vehicle travels.

A non-contact rotational speed sensor 35 for detecting rotational speed of the outer drum 25 is provided on inner peripheral surface of the case 7 to face outer peripheral surface of the outer drum 25 axially sideward of the brake mechanism 30. Therefore, without lengthening the drive apparatus 100 in axial direction, the rotational speed sensor 35 can be efficiently disposed in a radial gap between the case 7 and the outer drum 25.

The hydraulic pressure control unit 8 includes electromagnetic valve, proportional electromagnetic valve, and other control valves actuated in accordance with electric signals. These control valves operate to control hydraulic pressure flow to the brake mechanism 30, clutch mechanism 40 and the like in accordance with instructions from the controller 4. This enables ON-OFF switching of the brake mechanism 30 and clutch mechanism 40.

The controller 4 as an electric control unit incorporates an arithmetic processing unit having a CPU, ROM, RAM and other peripheral circuits. The controller 4 receives as input signals from, inter alia, the rotational speed sensor 35, a vehicle speed sensor 36 for detecting vehicle speed, and an accelerator opening angle sensor 37 for detecting accelerator opening angle indicative of amount of accelerator pedal depression. Based on these input signals, the controller 4 decides drive mode in accordance with a predefined driving force map representing vehicle driving force characteristics defined in terms of factors such as vehicle speed and accelerator opening angle. In order to enable the vehicle to travel in the decided drive mode, the controller 4 controls operation of the first and second motor-generators 2 and 3, the brake mechanism 30 and the clutch mechanism 40 by outputting control signals to, inter alia, the power control unit 5 and the hydraulic pressure control unit 8.

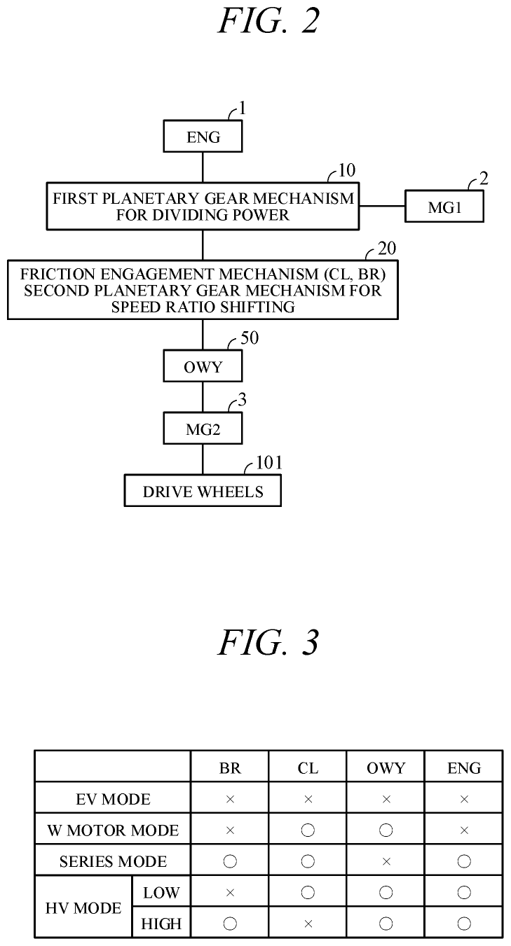

FIG. 2 is a drawing summarizing interconnection of main components of the drive apparatus 100. As shown in FIG. 2, the first planetary gear mechanism 10 for dividing engine power is connected to the engine 1. The first motor-generator 2 and second planetary gear mechanism 20 for speed ratio shifting are connected to the first planetary gear mechanism 10. The second motor-generator 3 is connected through the one-way clutch 50 to the second planetary gear mechanism 20, and the front wheels 101 are connected to the second motor-generator 3 as drive wheels.

FIG. 3 is a table showing examples of some drive modes that can be implemented by the drive apparatus 100 according to this embodiment of the present invention, along with operating states of the brake mechanism (BR) 30, clutch mechanism (CL) 40, one-way clutch (OWY) 50 and engine (ENG) 1 corresponding to the different modes.

In FIG. 3, EV mode, W motor mode, series mode and HV mode are shown as typical drive modes. HV mode is subdivided into low mode (HV low mode) and high mode (HV high mode). In the drawing, brake mechanism 30 ON (Engaged), clutch mechanism 40 ON (Engaged), one-way clutch 50 Locked, and engine 1 Operating are indicated by symbol “∘”, while brake mechanism 30 OFF (Disengaged), clutch mechanism 40 OFF (Disengaged), one-way clutch 50 Unlocked, and engine 1 Stopped are indicated by symbol “x”.

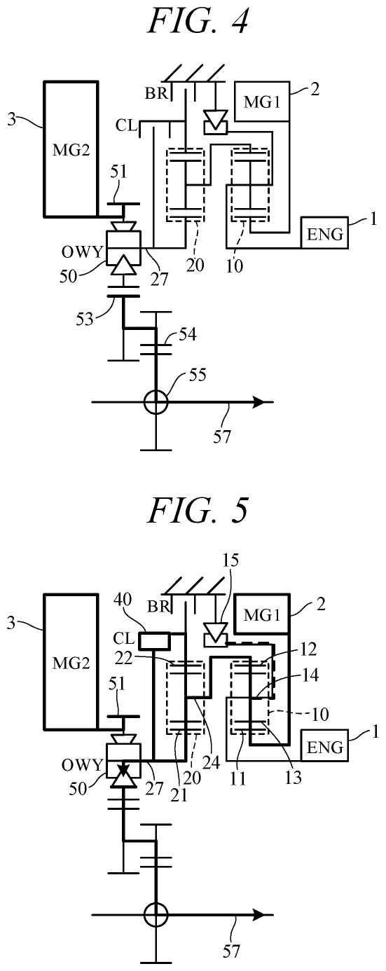

In EV mode, vehicle traveling is powered solely by motive power of the second motor-generator 3. As shown in FIG. 3, in EV mode, the brake mechanism 30 and clutch mechanism 40 are both OFF, and the engine 1 is stopped, in accordance with instructions from the controller 4. FIG. 4 is a skeleton diagram showing flow of torque transmission in EV mode.

As show in FIG. 4, in EV mode, torque output from the second motor-generator 3 is transmitted through the output gear 51, large-diameter gear 53, small-diameter gear 54 and differential unit 55 to the axles 57. At this time, the output shaft 27 stays stopped under action of the one-way clutch 50 and efficient vehicle running can be achieved without torque pulled back (rotational resistance) attributable to rotating elements upstream of the second motor-generator 3 (on second planetary gear mechanism side).

In W motor mode, vehicle traveling is powered by motive power of the first motor-generator 2 and the second motor-generator 3. As shown in FIG. 3, in W motor mode, the brake mechanism 30 is OFF, the clutch mechanism 40 is ON and the engine 1 is stopped, in accordance with instructions from the controller 4. FIG. 5 is a skeleton diagram showing flow of torque transmission in W motor mode.

As show in FIG. 5, in W motor mode, rotation of the first carrier 14 is prevented by action of the one-way clutch 15, and torque output from the first motor-generator 2 is transmitted through the first sun gear 11, first pinions 13, first ring gear 12, second carrier 24 (second carrier 24 rotating integrally with the second sun gear 21 and second ring gear 22) to the output shaft 27. Torque transmitted to the output shaft 27 is transmitted through the locked one-way clutch 50 to the output gear 51, and transmitted to the axles 57 together with torque output from the second motor-generator 3. Since torque from the first motor-generator 2 and second motor-generator 3 is applied to the axles 57 in this manner in W motor mode, propelling force can be increased to greater than in EV mode.

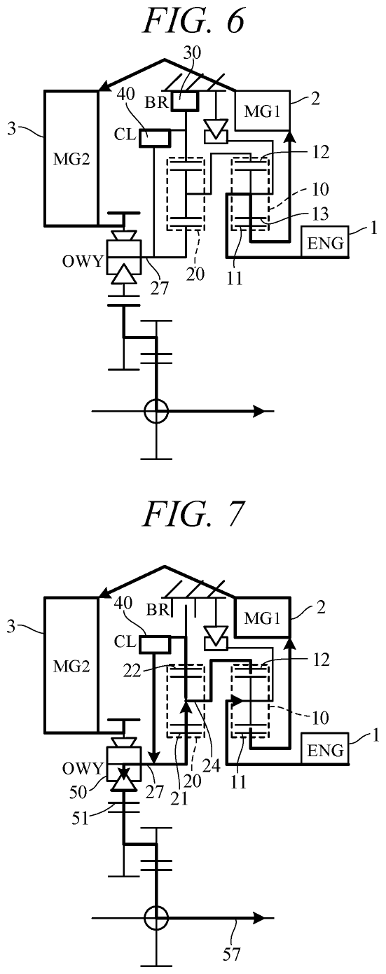

In series mode, vehicle traveling is powered by motive power of the second motor-generator 3 while the first motor-generator 2 is being driven by motive power from the engine 1 to generate electric power. As shown in FIG. 3, in series mode, the brake mechanism 30 and clutch mechanism 40 are both ON and the engine 1 is operated, in accordance with instructions from the controller 4. FIG. 6 is a skeleton diagram showing flow of torque transmission in series mode.

As shown in FIG. 6, in series mode, rotation from the first ring gear 12 to as far as the output shaft 27 is stopped, so that all power output from the engine 1 is input through the first pinions 13 and first sun gear 11 to the rotor rotating shaft 2a of the first motor-generator 2. The first motor-generator 2 is therefore driven to generate electric power and this generated electric power is used to drive the second motor-generator 3, whereby the vehicle can travel. In series mode, as in EV mode, pull back of torque is prevented by action of the one-way clutch 50.

In HV mode, vehicle traveling is powered by motive power produced by the engine 1 and the second motor-generator 3. Within the HV mode, the HV low mode corresponds to a mode of wide-open acceleration from low speed, and the HV high mode corresponds to a mode of normal traveling after EV traveling. As shown in FIG. 3, in HV low mode, the brake mechanism 30 is OFF, the clutch mechanism 40 is ON and the engine 1 is operated, in accordance with instructions from the controller 4. In HV high mode, the brake mechanism 30 is ON, the clutch mechanism 40 is OFF and the engine 1 is operated, in accordance with instructions from the controller 4.

FIG. 7 is a skeleton diagram showing flow of torque transmission in HV low mode. As shown in FIG. 7, in HV low mode, some torque output from the engine 1 is transmitted through the first sun gear 11 to the first motor-generator 2. As a result, the battery 6 is charged by power generated by the first motor-generator 2, and, in addition, electrical drive power is supplied from the battery 6 to the second motor-generator 3.

In HV low mode, remainder of torque output from the engine 1 is transmitted through the first ring gear 12 and the second carrier 24 (second carrier 24 rotating integrally with the second sun gear 21 and second ring gear 22) to the output shaft 27. Rotational speed of the output shaft 27 at this time is equal to rotational speed of the second carrier 24. Torque transmitted to the output shaft 27 is transmitted through the locked one-way clutch 50 to the output gear 51, and transmitted to the axles 57 together with torque output from the second motor-generator 3. This enables high-torque vehicle running using torque from the engine 1 and second motor-generator 3, while maintaining sufficient battery residual charge with power generated by the first motor-generator 2.

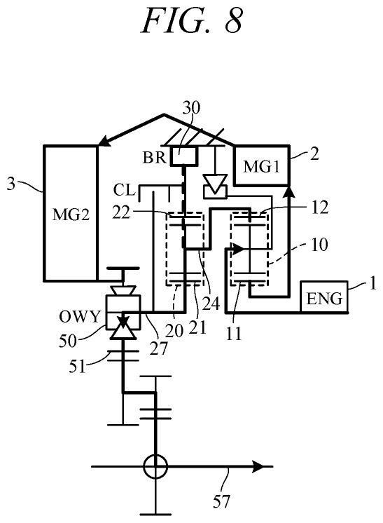

FIG. 8 is a skeleton diagram showing flow of torque transmission in HV high mode. As shown in FIG. 8, in HV high mode, similarly to in HIV low mode, some torque output from the engine 1, for example, is transmitted through the first sun gear 11 to the first motor-generator 2. Remainder of torque output from the engine 1 is transmitted through the first ring gear 12, second carrier 24 and second sun gear 21 to the output shaft 27. Rotational speed of the output shaft 27 at this time is greater than rotational speed of the second carrier 24.

Torque transmitted to the output shaft 27 is transmitted through the locked one-way clutch 50 to the output gear 51, and transmitted to the axles 57 together with torque output from the second motor-generator 3. Therefore, by utilizing torque from the engine 1 and second motor-generator 3 while maintaining sufficient battery residual charge, vehicle running can be achieved at torque that, while lower than that in HV low mode, is higher than that in EV mode. Since rotation of the output shaft 27 is speeded up by the second planetary gear mechanism 20 in HV high mode, running at lower engine speed than in HV low mode can be realized.

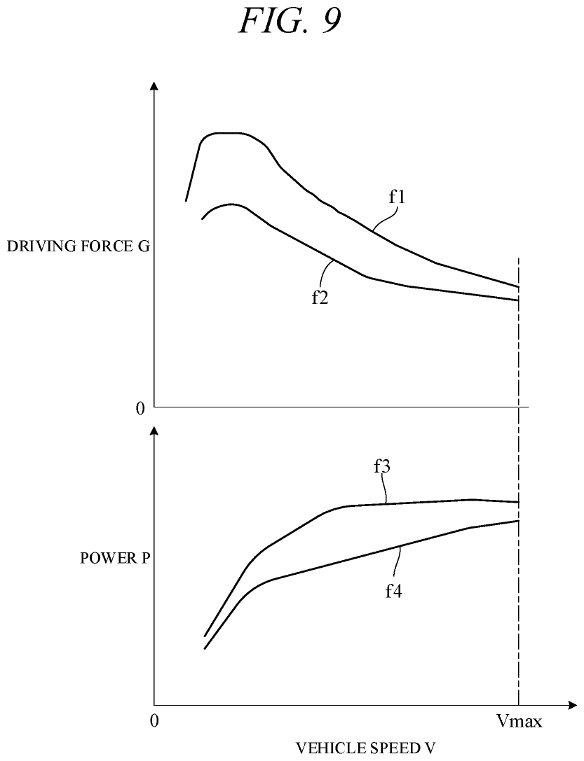

FIG. 9 is a diagram showing characteristic curves of driving force G and power P corresponding vehicle speed V during wide-open accelerator in HV low mode and HV high mode of the drive system 100 in accordance with the present embodiment. In the drawing, characteristic curves f1 and f3 represent HV low mode characteristics, and characteristic curves f2 and f4 represent HV high mode characteristics. As shown in FIG. 9, in the drive system 100 of the present embodiment, the characteristic curves f1 to f4 of driving force G and power P can be obtained from low speed (e.g., vehicle speed 0) up to maximum vehicle speed Vmax in both HV low mode and HV high mode, thereby enabling HV low mode and HV high mode traveling over the full range of vehicle speed V.

Further, the characteristic curves f1 and f3 in HV low mode is higher than the characteristic curves f2 and f4 in HV high mode over full range of vehicle speed V, concerning both driving force G and power P. However, as shown in the characteristic curves, driving force G in HV high mode in low speed range is sufficiently large (characteristic curve f2), and power P at maximum vehicle speed Vmax in HV high mode is also sufficiently large (characteristic curve f4). Therefore, in any of HV low mode and HV high mode, it is possible to obtain sufficient travel performance over full range of vehicle speed V.

Although not shown in the drawings, the drive system 100 can also implement drive modes other than the aforesaid, such as regeneration mode and engine braking mode. In regeneration mode, for example, both the brake mechanism 30 and the clutch mechanism 40 are turned OFF. As a result, the second motor-generator 3 is driven by torque from the axles 57 to produce regenerative electric power. In engine braking mode, the brake mechanism 30 and the clutch mechanism 40 are both turned ON. As a result, the second motor-generator 3 is driven by torque from the axles 57 to produce regenerative electric power that drives first motor-generator 2 accordingly. Since this applies motive power load to the engine 1, it causes an engine-braking-like pumping loss.

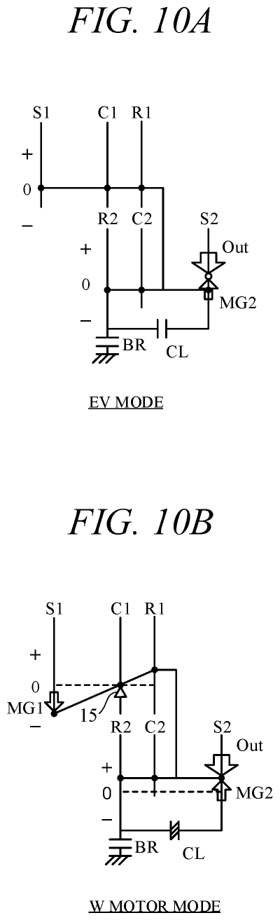

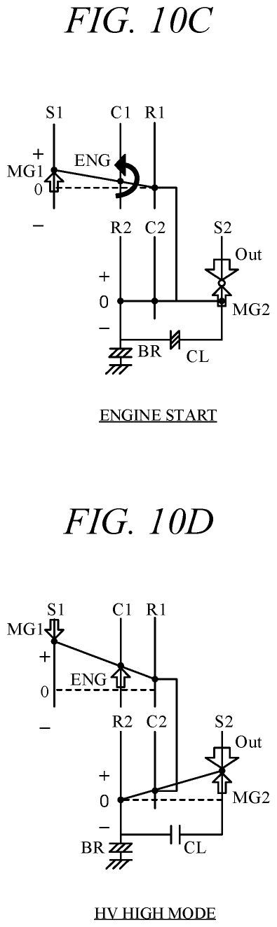

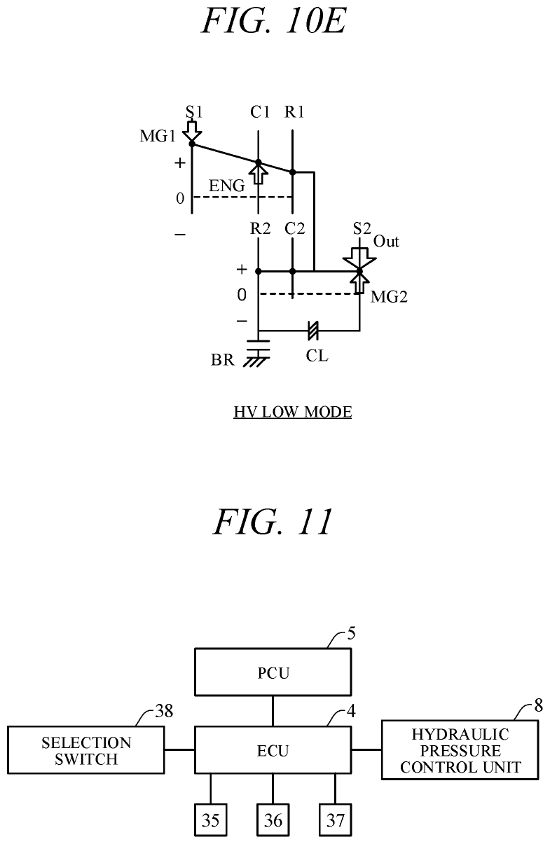

The operation of the drive apparatus 100 according to the embodiment of the invention is explained more specifically. FIGS. 10A to 10E are diagrams each showing an example of an alignment chart in a given drive modes. In the drawings, the first sun gear 11, first carrier 14 and first ring gear 12 are designated S1, C1 and R1, respectively, and the second sun gear 21, second carrier 24 and second ring gear 22 are designated S2, C2 and R2, respectively. Rotation direction of the first ring gear 12 and second carrier 24 during forward vehicle movement is defined as positive direction. Forward direction is indicated by symbol “+” and torque acting in forward direction is indicated by upward pointing arrow.

In EV mode, for example, the vehicle starts traveling in response to driver depression of the accelerator pedal. FIG. 10A is an alignment chart in EV mode. As shown in FIG. 10A, in EV mode, action of the one-way clutch 50 keeps rotation of the second sun gear 21 (S2) of the second planetary gear mechanism 20 stopped, and only the second motor-generator 3 (MG2) is driven to rotate in positive direction so that the vehicle traveling is started by driving torque from the second motor-generator 3.

When the required driving force is large at vehicle starting, the controller 4 switches drive mode from EV mode to, for example, W motor mode in accordance with the driving force map defined by the vehicle speed and accelerator opening angle. FIG. 10B is an alignment chart in W motor mode. As shown in FIG. 10B, in W motor mode, the clutch mechanism 40 (CL) is turned ON and the first motor-generator 2 (MG1) is driven to rotate in negative direction. At this time, since the one-way clutch 15 prevents the first carrier 14 (C1) from rotating, torque of the first motor-generator 2 (MG1) is transmitted from the first ring gear 12 (R1) to the second carrier 24 (C2) as a reaction force by being supported at the one-way clutch 15. Therefore, the second sun gear 21 (S2) and second ring gear 22 (R2) integrally rotate with the second carrier 24 (C2), and torque from the second sun gear 21 is added to torque of the second motor-generator 3 (MG2), so that the vehicle travels in W motor mode. In traveling at low vehicle speed, it is possible to switch to W motor mode.

The controller 4 switches drive mode from EV mode or W motor mode to, for example, HV low mode or HV high mode, along with the increasing of vehicle speed after the vehicle has started. In this case, the engine 1 first is started. FIG. 10C is an alignment chart showing a case of starting engine 1 from EV mode. In engine starting, as shown in FIG. 10C, while the second motor-generator 3 (MG2) is being kept rotationally driven in positive direction, the brake mechanism 30 (BR) and clutch mechanism 40 (CL) are both turned ON, and rotation of the second carrier 24 (C2) and first ring gear 12 (R1) is stopped. In this state, the first motor-generator 2 (MG1) is rotationally driven in positive direction to rotate the output shaft 1a of the engine 1 through the first carrier 14 (C1) and thereby start the engine 1.

When the required driving force for increasing vehicle speed is relatively small, the controller 4 switches drive mode to, for example, HV high mode. FIG. 10D is an alignment chart in HV high mode. As shown in FIG. 10D, when drive mode is being switched to HV high mode, engine starting is followed by turning ON the brake mechanism 30 (BR) and turning OFF the clutch mechanism 40 (CL). Therefore, the first carrier 14 (C1) is rotated in positive direction by the engine 1 and the first motor-generator 2 (MG1) is driven to rotate and starts to generate electricity, and the first ring gear 12 (R1) rotates in positive direction. Since the second ring gear 22 (R2) is stopped, the second sun gear 21 (S2) rotates at speed higher than the second carrier 24 (C2). The vehicle is traveled by this torque from the second sun gear 21 and torque of the second motor-generator 3 (MG2).

When the required driving force for increasing vehicle speed is relatively large, the controller 4 switches drive mode to, for example, HV low mode. FIG. 10E is an alignment chart in HV low mode. As shown in FIG. 10E, when drive mode is being switched to HV low mode, engine starting is followed by turning OFF the brake mechanism 30 (BR) and turning ON the clutch mechanism 40 (CL). Therefore, the first carrier 14 (C1) is rotated in positive direction by the engine 1 and the first motor-generator 2 (MG1) is driven to rotate and starts to generate electricity, and the first ring gear 12 (R1) rotates in positive direction. In this case, since the second carrier 24 (C2), second sun gear 21 (S2) and second ring gear 22 (R2) are integrally configured, the second sun gear 21 (S2) rotates at same speed as the second carrier 24 (C2). The vehicle is traveled by this torque from the second sun gear 21 and torque of the second motor-generator 3 (MG2).

Switching from HV high mode to HV low mode can be achieved by turning the brake mechanism 30 OFF after turning the brake mechanism 30 and clutch mechanism 40 ON. In other words, switching to HV low mode can be performed by turning the clutch mechanism 40 ON to once switch from HV high mode to series mode, and thereafter turning the brake mechanism 30 OFF. Similarly, switching from HV low mode to HV high mode can be achieved by turning the brake mechanism 30 and clutch mechanism 40 ON and thereafter turning the clutch mechanism 40 OFF. In other words, switching to HV high mode can be performed by turning the brake mechanism 30 ON to once switch from HV low mode to series mode, and thereafter turning the clutch mechanism 40 OFF.

Thus in the present embodiment, when mode is switched between HV low mode and HV high mode, drive mode only once switches to series mode even if the pair of engaging elements (brake mechanism 30 and clutch mechanism 40) are simultaneously engaged. It is therefore possible to inhibit occurrence of negative acceleration caused by pull back of torque in torque phase or inertia phase as occurs in so-called clutch-to-clutch control. Speed ratio stage can therefore be switched smoothly with good responsiveness, while having a large step ratio. In contrast, in the configuration switched to series mode by disengaging a pair of engaging elements at the same time, when the pair of engaging elements are simultaneously engaged at the time of switching mode between the HV low mode and the HV high mode, it is difficult to smoothly shift speed ratio due of occurrence of negative acceleration caused by pull back of torque in torque phase or inertia phase as occurs in clutch-to-clutch control.

Turning the clutch mechanism 40 ON or OFF (switching to low or high) is carried out based on signal from the rotational speed sensor 35. More specifically, the rotational speed sensor 35 detects change of rotational speed of the outer drum 25 of the clutch mechanism 40 in shift transient state (during switching to low or high), and the engine 1, first motor-generator 2, second motor-generator 3, brake mechanism 30 and clutch mechanism 40 are coordinately controlled based on the detected value. Therefore, controllability of switching to low or high is improved.

Further, in the present embodiment, HV mode includes switchable two mode, i.e., HV low mode having large step ratio and HV high mode. Therefore, the vehicle can travel in each mode by selecting in each mode operation point at which power of the first motor-generator 2 is small, whereby it is possible to decrease maximum rotational speed of the first motor-generator 2. As a result, stress generated in the first motor-generator 2 is reduced, and inner diameter of the first motor-generator 2 can be easily enlarged.

The present embodiment can achieve advantages and effects such as the following:

(1) The drive apparatus 100 of the hybrid vehicle according to the present embodiment includes: an engine 1; a first planetary gear mechanism 10 to which power generated by the engine 1 is input; a first motor-generator 2 connected to the first planetary gear mechanism 10; a second planetary gear mechanism 20 including a second sun gear 21, a second carrier 24 and a second ring gear 22 so that power output from the first planetary gear mechanism 10 is input thereto through the second carrier 24; rotating members such as an output shaft 27 and output gear 51 for transmitting power output from the second sun gear 21 of the second planetary gear mechanism 20 to axles 57; a second motor-generator 3 connected to the output gear 51 to transmit power to the axles 57 through the output gear 51; a one-way clutch interposed between the output shaft 27 and a rotating shaft 3a of the second motor-generator 3 to allow a relative rotation of the rotating shaft 3a with respect to the output shaft 27 in forward direction and prohibit the relative rotation in reverse direction; a brake mechanism 30 braking or non-braking the second ring gear 22 of the second planetary gear mechanism 20 by engaging or disengaging; a clutch mechanism 40 integrally joining the second sun gear 21 and the second ring gear 22 of the second planetary gear mechanism 20 or separating from each other by engaging or disengaging; and a controller 40 controlling the brake mechanism 30 and the clutch mechanism 40 (FIGS. 1 and 2).

Therefore, in the drive apparatus 100 of the hybrid vehicle of two motor type configured to divide and output power from the engine 1 to the first motor-generator 1 and the second planetary gear mechanism 20, it is possible to switch shift mode between HV low mode with small speed ratio and HV high mode with large speed ratio by controlling respective engaging operations of the single brake mechanism 30 and the single clutch mechanism 40, not depending on so-called clutch-to-clutch control. Thus, it is possible to enhance the response of speed ration changing with a simple configuration without torque pull back when switching to low or high. In other words, decrease of power in speed ratio changing caused by switching operation of the brake mechanism 30 and the clutch mechanism 40 is reduced, and speed ratio changing can be carried out efficiently and smoothly.

(2) The controller 40 controls the brake mechanism 30 and the clutch mechanism 40 to disengage the brake mechanism 30 and the clutch mechanism 40 in EV mode in which the vehicle is driven by power of the second motor-generator 3 with the engine 1 stopped, to engage the brake mechanism 30 and the clutch mechanism 40 in series mode in which the vehicle is driven by power of the second motor-generator 2 with the first motor generator 2 generated by power of the engine 1, and to engage one of the brake mechanism 30 and the clutch mechanism 40 and disengage the other in HV mode in which the vehicle is driven by power of the engine 1 and power of the second motor-generator 3 (FIG. 3). This enables typical drive modes of a hybrid vehicle, namely, EV mode, HV mode and series mode, to be readily achieved with a simple configuration solely for controlling engaging actions of the brake mechanism 30 and the clutch mechanism 40.

(3) The HV mode includes HV low mode corresponding to a powerful acceleration and HV high mode corresponding to a common driving, and action of the one-way clutch 50 is utilized to implement series mode in the course of shifting between HV low mode and HV high mode. The controller 40 controls the brake mechanism 30 and the clutch mechanism 40 to disengage the brake mechanism 30 and engage the clutch mechanism 40 in HV low mode, and to engage the brake mechanism 30 and disengage the clutch mechanism 40 in HV high mode (FIG. 3). Therefore, it is possible to achieve HV low mode or HV high mode by disengaging the brake mechanism 30 or the clutch mechanism 40 from a state of series mode in which brake mechanism 30 and the clutch mechanism 40 are engaged. Thus, low-high switching can be carried out with good responsiveness while reducing torque pull back caused by overlapping engagement of the two frictional engagement mechanisms and/or reaction force of the first motor-generator 2.

(4) The engine 1, the first motor-generator 2, the second motor-generator 3, the first planetary gear mechanism 10 and the second planetary gear mechanism 20 are arranged so that a center of the output shaft 1a of the engine 1, a center of the first motor-generator 2, a center of the second motor-generator 3, a center of the first planetary gear mechanism 10 and a center of the second planetary gear mechanism 20 are positioned on a common axis CL1 (FIG. 1). Therefore, whole drive apparatus 100 can be configured compact in radial direction and downsized. Further, due to a reduced height of the drive apparatus 100, the power control unit 5 can be easily installed.

(5) The first motor-generator 2 is formed in a substantially cylindrical shape, and the first planetary gear mechanism 10 is installed on radial inner side of the first motor-generator 2 (FIG. 1). Therefore, it is possible to shorten length of the drive apparatus 100 in axial direction and downsize the drive apparatus 100. Further, in the present embodiment, by selecting operation point corresponding to small power of the first motor generator 2 in HV low mode and HV high mode, maximum rotational speed of the first motor-generator 2 is decreased, whereby inner diameter of the first motor-generator 2 can be increased without strength problem.

(6) The second motor-generator 3 is formed in a substantially cylindrical shape, and the one-way clutch 50 is installed on radial inner side of the second motor-generator 3 (FIG. 1). Therefore, it is possible to shorten length of the drive apparatus 100 in axial direction and downsize the drive apparatus 100.

(7) The drive apparatus further includes a case 7 enclosing the second planetary gear mechanism 20, and the brake mechanism 30 is provided so that a disc 32 extending in radial direction from the outer periphery of the ring gear 22 of the second planetary gear mechanism 20 is engageable with a plate 31 extending in radial direction from the inner peripheral wall of the case 7. Therefore, a necessary and sufficient amount of cooling oil can be easily supplied to the brake mechanism 30 from both rotating shaft (output shaft 27, etc.) and outer side of the case 7. As a result, it is possible to decrease the number of friction members and downsize the brake mechanism 30.

(8) The clutch mechanism 40 includes an outer drum 25 rotating integrally with the second ring gear 22 of the second planetary gear mechanism 20 centered on the axis CL1, and an inner drum 26 rotating integrally with the second sun gear 21 of the second planetary gear mechanism 20, and is provided so that a plate 41 extending from the outer drum 25 in radial direction is engageable with a disc 42 extending from the inner drum 26 in radial direction (FIG. 1). Therefore, configuration of an oil passage up to the clutch mechanism 40 can be simplified. Further, since heating value in the clutch mechanism 40 is smaller than heating value in the brake mechanism 30, the clutch mechanism 40 can be downsized due to decrease of friction members, etc. In addition, it is possible to easily install bearing for supporting the output shaft 27, etc.

(9) The drive apparatus further includes a rotational speed sensor 35 disposed on radial outer side of the outer drum 25 to detect rotational speed of the outer drum 25 (FIG. 1). Therefore, without lengthening the drive apparatus 100 in axial direction, the rotational speed sensor 35 can be efficiently disposed in a radial gap between the case 7 and the outer drum 25. Controllability of low-high switching based on signal from the rotational speed sensor 35 improves.

Various modifications of the aforesaid embodiment are possible. Examples are explained below. FIG. 11 is a block diagram showing an example of modification of control apparatus included in the drive apparatus 100. In the example of FIG. 11, a selection switch 38 is connected to the controller 40 in addition to the configuration in FIG. 1. The selection switch (a selection part) 38 is a switch configured to select one of eco-mode (a first mode) in which fuel economy performance is prioritized over power performance and sport mode (a second mode) in which power performance is prioritized over fuel economy performance. The configurations of the selection part, the first mode and second mode are not limited to this configurations.

The controller 4 selects one of EV mode, series mode, HV low mode and HV high mode in accordance with vehicle speed detected by the vehicle speed sensor 36 and accelerator opening angle detected by the accelerator opening angle sensor 37. In particular, when eco-mode is selected by the selection switch 38, the controller 40 selects one from among EV mode, series mode and HV high mode in accordance with the vehicle speed and accelerator opening angle. In other words, the controller selects one from among modes other than HV low mode. Therefore, since increase of engine rotational speed and noise is reduced, the vehicle can travel focusing on fuel economy performance. On the other hand, when sport mode is selected by the selection switch 38, the controller 40 selects one from among EV mode, series mode and HV low mode in accordance with the vehicle speed and accelerator opening angle. In other words, the controller selects one from among modes other than HV high mode. Therefore, since acceleration performance is improved, the vehicle can travel focusing on power performance.

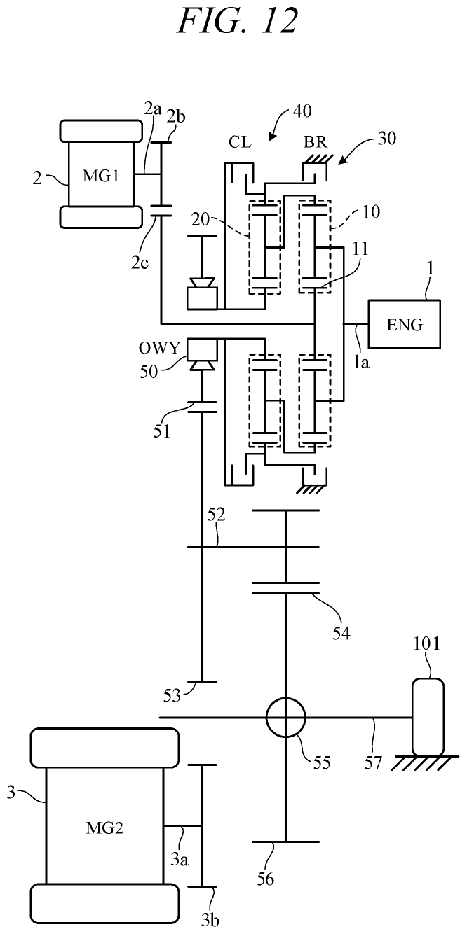

FIG. 12 is a skeleton diagram showing a modification of FIG. 1. Configurations in common with those of FIG. 1 are assigned like reference symbols in FIG. 12. In FIG. 12, a rotating shaft 2a of the first motor-generator 2 and a rotating shaft 3a of the second motor-generator 3 are respectively arranged on different axes from the output shaft 1a of the engine 1, unlike the configuration of FIG. 1. The rotating shaft 2a of the first motor-generator 2 is connected to the first sun gear 11 through a gear 2b rotating integrally with the rotating shaft 2a and a gear 2c. The rotating shaft 3a of the second motor-generator 3 is connected to the counter shaft 52 through a gear 3b rotating integrally with the rotating shaft 3a and the large-diameter gear 53.

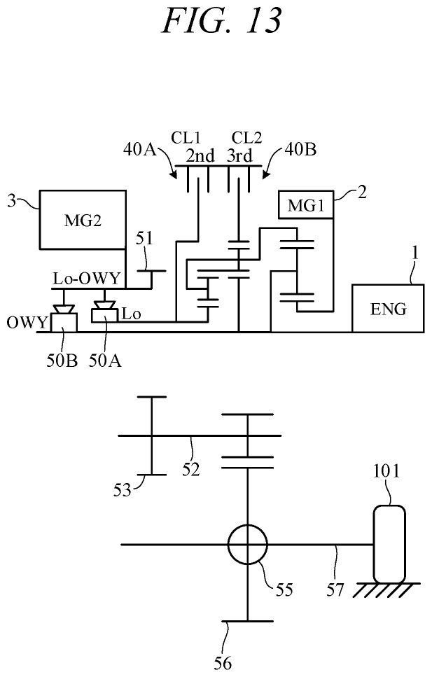

FIG. 13 is a skeleton diagram showing another modification of FIG. 1. In FIG. 13, a pair of clutch mechanisms (CL1 and CL2) 40A and 40B are disposed and a pair of one-way clutches are disposed between a planetary gear mechanism and the second motor-generator 3, and further in HV mode, speed stage can be changed to three speed stage (low, second and third). In HV low mode, the clutch mechanisms are respectively turned OFF. At this time, the one-way clutch 50A is locked. In HV second mode, the clutch mechanism 40A is turned ON and the clutch mechanism 40B is turned OFF. In HV third mode, the clutch mechanism 40A is turned OFF and the clutch mechanism 40B is turned ON. In series mode, the clutch mechanisms 40A and 40B are respectively turned ON.

In the aforesaid embodiment (FIG. 1), the brake mechanism 30 is configured to engage the plates 31 and disks 32 using pushing force of hydraulic pressure. However, the plates 31 and disks 32 can instead be engaged using spring biasing force and disengaged using hydraulic pressure. Similarly, as regards the clutch mechanism 40, the plates 41 and disks 42 can be engaged using spring biasing force and disengaged using hydraulic pressure. Although multi-plate wet type engagement elements are used in the brake mechanism 30 and clutch mechanism 40, band brake, dog or other type of engagement elements can be used instead. In other words, a brake mechanism and a clutch mechanism are not limited to the aforesaid configurations.

In the aforesaid embodiment (FIG. 1), the power transmission path for transmitting motive power output from the second sun gear 21 to the axles 57 is formed by the output shaft 27, output gear 51, etc., and the second motor-generator 3 is connected to the power transmission path to transmit motive power of the second motor-generator 3 to the axles 57. However, a path forming part is not limited to this configuration. In the aforesaid embodiment (FIG. 1), the one-way clutch 50 is interposed between the output shaft 27 connected to the second sun gear 21 and the rotating shaft 3a of the second motor-generator 3. However, location of an one-way clutch is not limited to the aforesaid insofar as it is located between a sun gear of a second planetary gear mechanism and an output shaft of a second motor-generator.

In the aforesaid embodiment, the controller 4 is adapted to control actions of the brake mechanism 30 and clutch mechanism 40 so as to implement EV mode, W motor mode, series mode, HV low mode (first HV mode), HV high mode (second HV mode) and the like, but can also be adapted to implement other modes. In the aforesaid embodiment, rotational speed of the outer drum (a first rotor) 25 is detected by the rotational speed sensor 35, vehicle speed is detected by the vehicle speed sensor 36, and required driving force is detected by the accelerator opening angle sensor 37. However, a rotational speed detection part, a vehicle speed detection part and a required driving force detection part are not limited to the aforesaid configurations. A first rotor and a second rotor configuring a clutch mechanism may be other than the outer drum 25 and the inner drum 26.

In the aforesaid embodiment, drive mode is switched to one of various drive modes based on a driving force map according to vehicle speed and accelerator opening angle. In this connection, considering that heating value of the brake mechanism 30 at the time of engaging is greater than heating value of the clutch mechanism 40 at the time of engaging, switching to HV high mode may be prohibited in a high vehicle speed region in which differential rotational speed between the plate 31 and the disc 32 is large and heating value tends to become large. In other words, when vehicle speed is equal to or greater than a predetermined value, switching from HV low mode to HV high mode may be prohibited.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LOST

1 engine, 2 first motor-generator, 3 second motor-generator, 4 controller, 7 case, 10 first planetary gear mechanism, 20 second planetary gear mechanism, 21 second sun gear, 22 second ring gear, 25 outer drum, 26 inner drum, 27 output shaft, 30 brake mechanism, 35 rotational speed sensor, 36 vehicle speed sensor, 37 accelerator opening angle sensor, 38 selection switch, 40 clutch mechanism, 50 one-way clutch, 51 output gear, 100 drive apparatus

1-10. (canceled)

11. A drive apparatus of a hybrid vehicle, comprising:
an internal combustion engine;
a first planetary gear mechanism to which power generated by the internal combustion engine is input;
a first motor-generator connected to the first planetary gear mechanism;
a second planetary gear mechanism including a sun gear, a carrier and a ring gear so that power output from the first planetary gear mechanism is input to the second planetary gear mechanism through the carrier;
a path forming part configured to form a power transmission path so as to transmit power output from the sun gear of the second planetary gear mechanism to a wheel axle;
a second motor-generator connected to the power transmission path to transmit power to the wheel axle through the power transmission path;
a one-way clutch interposed between the sun gear of the second planetary gear mechanism and an output shaft of the second motor-generator in the power transmission path to allow a relative rotation of the output shaft with respect to the sun gear in one direction and prohibit the relative rotation of the output shaft in an opposite direction;
a brake mechanism configured to brake or non-brake the ring gear of the second planetary gear mechanism by engaging or disengaging;
a clutch mechanism configured to integrally join the sun gear and the ring gear of the second planetary gear mechanism or separate from each other by engaging or disengaging; and
an electronic control unit having a microprocessor and a memory, wherein
the microprocessor is configured to perform
controlling the brake mechanism and the clutch mechanism.

12. The drive apparatus according to claim 11, wherein
the microprocessor is configured to perform
the controlling including
disengaging the brake mechanism and the clutch mechanism, respectively, in an EV mode in which the vehicle is driven by the power of the second motor-generator with the internal combustion engine stopped,
engaging the brake mechanism and the clutch mechanism, respectively, in a series mode in which the vehicle is driven by the power of the second motor-generator with the first motor generator generated by the power of the internal combustion engine, and
engaging one of the brake mechanism and the clutch mechanism and disengaging the other of the brake mechanism and the clutch mechanism in an HV mode in which the vehicle is driven by the power of the internal combustion engine and the power of the second motor-generator.

13. The drive apparatus according to claim 12, wherein
the HV mode includes a first HV mode corresponding to a first speed stage and a second HV mode corresponding to a second speed stage of a high speed side than the first speed stage, and
the microprocessor is configured to perform
the controlling including
disengaging the brake mechanism and engaging the clutch mechanism in the first HV mode, and
engaging the brake mechanism and disengaging the clutch mechanism in the second HV mode.

14. The drive apparatus according to claim 13, further comprising:
a vehicle speed detection part configured to detect a vehicle speed;
a required driving force detection part configured to detect a required driving force; and
a selection part configured to select a first mode in which a fuel economy performance is prioritized over a power performance or a second mode in which the power performance is prioritized over the fuel economy performance, wherein
the microprocessor is configured to further perform
selecting a drive mode, and
the microprocessor is configured to perform
the selecting including
selecting one of the EV mode, the series mode and the first HV mode in accordance with the vehicle speed detected by the vehicle speed detection part and the required driving force detected by the required driving force detection part when the first mode is selected by the selection part, and
selecting one of the EV mode, the series mode and the second HV mode in accordance with the vehicle speed detected by the vehicle speed detection part and the required driving force detected by the required driving force detection part when the second mode is selected by the selection part.

15. The drive apparatus according to claim 1, wherein
the internal combustion engine, the first motor-generator, the second motor-generator, the first planetary gear mechanism and the second planetary gear mechanism are arranged so that a center of an output shaft of the internal combustion engine, a center of the first motor-generator, a center of the second motor-generator, a center of the first planetary gear mechanism and a center of the second planetary gear mechanism are positioned on an axial line, respectively.

16. The drive apparatus according to claim 15, wherein
the first motor-generator is formed in a substantially cylindrical shape, and the first planetary gear mechanism is installed on a radial inner side of the first motor-generator.

17. The drive apparatus according to claim 15, wherein
the second motor-generator is formed in a substantially cylindrical shape, and the one-way clutch is installed on a radial inner side of the second motor-generator.

18. The drive apparatus according to claim 15, further comprising
a case configured to enclose the second planetary gear mechanism, wherein
the brake mechanism is provided so that an outer periphery of the ring gear of the second planetary gear mechanism is engageable with an inner peripheral wall of the case.

19. The drive apparatus according to claim 15, wherein
the clutch mechanism includes a first rotor rotating integrally with the ring gear of the second planetary gear mechanism and a second rotor rotating integrally with the sun gear of the second planetary gear mechanism, and is provided so that the second rotor is engageable with the first rotor.

20. The drive apparatus according to claim 19, wherein
the first rotor is formed in a substantially cylindrical shape centered on the axial line, and
the drive apparatus further comprises a rotational speed detection part disposed on a radial outer side of the first rotor to detect a rotational speed of the first rotor.
